(19) United States
(12) Patent Application Publication
(10) Pub. No.: US 2007/0286338 A1
(43) Pub. Date: Dec. 13, 2007

(54) METHOD AND SYSTEM OF INSPECTING BAGGAGE

(76) Inventors: Bradley Thurman Sykes, Half Moon Bay, CA (US); Pierfrancesco Landolfi, Newark, CA (US); Glenn James Ignazio, Sunnyvale, CA (US); John Howard Davis, San Jose, CA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/688,506

(22) Filed: Mar. 20, 2007

Related U.S. Application Data
(60) Provisional application No. 60/787,881, filed on Mar. 31, 2006.

(51) Int. Cl. G01N 23/04

(52) U.S. Cl. 378/57

(57) ABSTRACT

A method of inspecting baggage includes establishing an inspection workstation including an inspection area and a scanning system, providing a computer system including a graphical user interface including a plurality of icons and scanning at least one item of baggage for contraband during an initial inspection. The method also includes detecting at least one item of contraband, determining an identity of the at least one item of contraband and determining whether the at least one item of contraband is safe. The method further includes storing the identity of the at least one item of contraband in the computer system and associating the identity of the at least one item of contraband with the at least one item of baggage.

### RELATED APPLICATION

The present application relates to and claims priority from Provisional Application Ser. No. 60/787,881, filed Mar. 31, 2006, titled “BAGGAGE SCREENING SYSTEM”, the complete subject matter of which is hereby expressly incorporated by reference in its entirety.

### BACKGROUND OF THE INVENTION

This invention relates generally to baggage screening systems, and more particularly, to methods and systems for efficiently storing and accessing baggage information associated with baggage inspections.

Baggage loaded onto passenger planes is either inspected with a certified technology, such as X-ray CT, for example, or manually inspected. It is expected that cargo items loaded on passenger planes will soon have to go through the same level of scrutiny.

While the certified systems are highly reliable in identifying various contraband such as explosives, at least some of the baggage may cause the inspection system to experience a false positive signal. For example, baggage that is identified as possibly including contraband is displayed to security personnel. Based on a given protocol security personnel will determine whether the baggage is to be manually inspected, or is considered safe. During manual inspection, the baggage may be opened and searched by hand to ensure that the baggage does not include any contraband.

Once the bag is opened, security personnel may utilize the displayed images to identify the item causing the alarm. At this point security personnel are required to record certain information, such as, but not limited to, the name and identification number of the person conducting the inspection, the International Air Transport Association (IATA) bag identification, the bag destination, and/or the nature of the object that caused the alarm. Currently, this information is recorded on paper and may be needed at a later time should questions about the manual search or bag arise.

More specifically, once security personnel identify the item of interest, relevant information pertaining to the item of interest is handwritten in a log book by security personnel. At some future time, the information in the logbook may be manually entered in to an electronic database and stored for future use if desired. However, since the quantity of baggage requiring manual hand inspection may be quite large, it is often relatively time consuming to enter information pertaining to each piece of baggage into a logbook and then manually enter the same information into an electronic database at a later time. Moreover, retrieving old data, which may become necessary if a passenger complaint is received, is often difficult when the information is stored in a handwritten log that has not yet been manually entered into the electronic database.

For the reasons stated above, and for other reasons discussed below, which will become apparent to those skilled in the art upon reading and understanding the present disclosure, there are needs unsolved by these related approaches to provide for quickly and accurately recording baggage information that can be quickly and accurately retrieved.

### BRIEF DESCRIPTION OF THE INVENTION

The above-mentioned shortcomings, disadvantages and problems are addressed herein, which will be understood by reading and studying the following disclosure. Embodiments of the invention provide for quickly and accurately recording baggage information that can also be quickly and accurately retrieved.

In one aspect, a method of inspecting baggage is provided. The method includes establishing an inspection workstation including an inspection area and a scanning system, providing a computer system including a graphical user interface including a plurality of icons and scanning at least one item of baggage for contraband during an initial inspection. The method also includes detecting at least one item of contraband, determining an identity of the at least one item of contraband and determining whether the at least one item of contraband is safe and storing the identity of the at least one item of contraband in the computer system and associating the identity of the at least one item of contraband with the at least one item of baggage.

In another aspect, a system of inspecting baggage is provided. The system includes an inspection workstation including an inspection area and a scanning system configured to scan at least one item of baggage for contraband during an initial inspection. The system also includes a user interface configured to detect at least one item of contraband, store an identity of the at least one item of contraband, and associate the identity with the at least one item of baggage. If the at least one item of baggage is subsequently scanned, and the at least one item of contraband detected, the user interface determines the identity of the at least one item of contraband.

In yet another aspect, a baggage inspection apparatus is provided. The apparatus includes a scanning system configured to scan at least one item of baggage during an initial inspection and a processor configured to detect at least one item of contraband, store an identity of the at least one item of contraband, and associate the identity with the at least one item of baggage. If the at least one item of baggage is subsequently scanned and the at least one item of contraband detected, the processor provides the identity of the at least one item of contraband.

### BRIEF DESCRIPTION OF THE DRAWINGS

FIG. 1 is a simplified block diagram of a Baggage Inspection System (BIS) in accordance with one embodiment of the present invention;

FIG. 2 is a simplified block diagram of an example embodiment of a server architecture of a Baggage Inspection System User Interface (BISUI) in accordance with one example embodiment of the present invention;

FIG. 3 is an expanded version block diagram of an example embodiment of a server architecture of the BISUI system; and

FIG. 4 is a flowchart illustrating exemplary processes utilizing a Baggage Inspection System.

### DETAILED DESCRIPTION OF THE INVENTION

The methods and systems described herein facilitate reducing the time required to enter and store baggage information on a computer system. The methods and systems described herein are believed to be applicable to many different businesses for reducing the time required to accurately enter and store baggage information for quick retrieval. The example embodiment described herein is the transportation security business. Although the transportation security business is the example business described herein, the invention is in no way limited to the transportation security business. For example, the invention may also be used to enter and store proper package information for packages handled by freight carriers. It should be appreciated that the term “baggage” as used herein includes any item transported on a craft, such as a train, plane, boat or automobile. Such items include, but are not limited to, suitcases, boxes, trunks, carry-on bags or any kind of container.

Exemplary embodiments of systems and processes that facilitate integrated network-based electronic verification of proper entry and storage of baggage information are described below in detail. The systems and processes facilitate, for example, reducing the time required to enter and store baggage information using a Baggage Inspection Security (BIS) system. A technical effect of the systems and processes described herein include at least one of permitting an entity to accurately and quickly enter and store baggage information that may be shared with other airport security systems. More specifically, in the example embodiment, airport security businesses or other entities engaged in the business of providing baggage inspection services in airports, utilize the methods and systems of the example embodiment to quickly and accurately enter and store baggage information.

In the exemplary embodiment, the BIS system is utilized to quickly and accurately enter and store baggage information. At least some of the parties that may be involved in these systems and processes include airports, system administrators, security personnel and travelers. Airports provide facilities for aircraft, for security personnel conducting manual luggage inspections and for travelers who are passengers on aircraft. The system administrator refers to the individuals who maintain the BIS system. Security personnel refers to those individuals who operate the BIS system and manually inspect luggage intended for transport on aircraft. Travelers are passengers on the crafts.

In the example embodiment, users of the BIS system are able to perform many tasks, such as, but not limited to, quickly and accurately entering and storing baggage information. In the example embodiment, the BIS system includes an inspection workstation area having a BIS User Interface (BISUI) system and communication links. The inspection workstation area is electronically coupled to the BISUI system using a communications link such that they communicate with each other.

In the example embodiment, an item of baggage is processed through an airport inspection workstation area. During processing through the area, information such as a Baggage Identification Number (BIN) identifying the baggage is entered and stored using the BIS system. The inspection date and time is also stored. Storing baggage information creates a link between the inspected baggage and its inspection data. This link enables quickly and accurately retrieving inspection information for each item of baggage inspected.

It should be appreciated that although the example discussed above is from the transportation security business, the BIS system may be used in any other business or field of endeavor requiring accurate entry and storage of event information. However, it should be further appreciated that other businesses or organizations may define different criteria for entering and storing information that is tailored to the particular business, so entry and storage criteria may be different.

In one embodiment, a computer program is provided, and the program is embodied on a computer readable medium and utilizes a Structured Query Language (SQL) with a user interface for administration and an interface for standard input and generating reports. In an exemplary embodiment, the system is run on a business-entity intranet. In a further exemplary embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

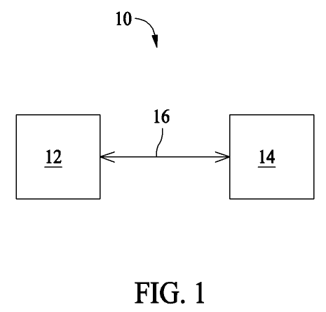

FIG. 1 is a simplified block diagram of an exemplary embodiment of a Baggage Inspection Security (BIS) system 10 for improving the visibility of a scanned image. More specifically, BIS system 10 includes a BIS User Interface (BISUI) system 12, an inspection workstation 14 and a communications link 16. BISUI system 12 is described in detail below. It should be understood that inspection workstation 14 includes an inspection area for manually or otherwise inspecting baggage. Moreover, in the exemplary embodiment, the inspection area includes any known technology that provides high resolution volume images (i.e. three-dimensional images) of baggage contents in an airport environment. For example, inspection workstation 14 may include scanning system technologies, such as, but not limited to, computed tomography scanning systems and magnetic resonance imaging scanning systems. Moreover, inspection workstation 14 includes a movement device or mechanism (not shown) for moving baggage through the scanning system, such as, but not limited to, a conveyor belt. Communications link 16 electronically couples BISUI system 12 to inspection workstation 14 such that information may flow through link 16 from inspection workstation system 14 to BISUI system 12, and vice versa. It should be understood that BISUI system 12 may be positioned at any location relative to inspection workstation 14.

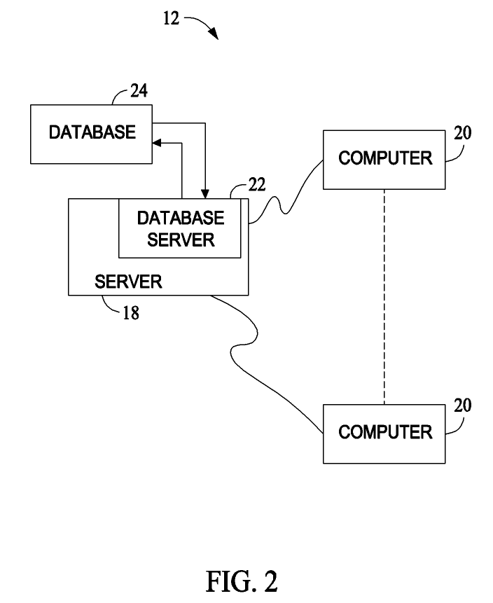

FIG. 2 is a simplified block diagram of a BISUI system 12 including a server system 18, and a plurality of client sub-systems, also referred to as client systems 20, connected to server system 18. Computerized modeling and grouping tools, as described below in more detail, are stored in server 18 and can be accessed by a requester at any one of computers 20. A database server 22 is connected to a database 24 containing information on a variety of matters, as described below in greater detail. In one embodiment, centralized database 24 is stored on server system 18 and can be accessed by potential users at one of client systems 20 by logging onto server system 18 through one of client systems 20. In an alternative embodiment, database 24 is stored remotely from server system 18 and may be non-centralized.

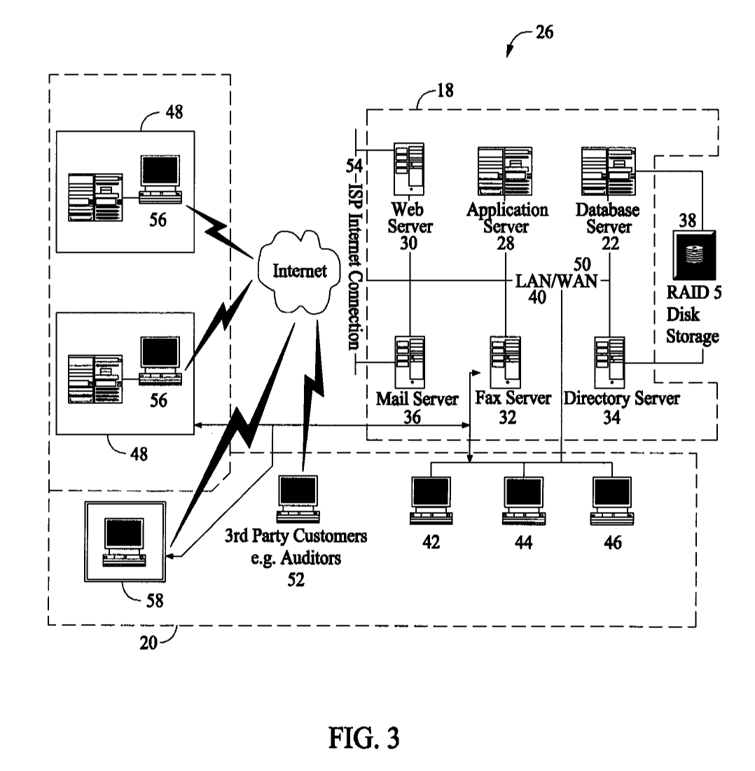

FIG. 3 is an expanded block diagram of an exemplary embodiment of a server architecture of BISUI system 26. Components in BISUI system 26, identical to components of system 12 (shown in FIG. 2), are identified in FIG. 3 using the same reference numerals as used in FIG. 2. BISUI system 26 includes server system 18 and client systems 20. Server system 18 further includes database server 22, an application server 28, a web server 30, a fax server 32, a directory server 34, and a mail server 36. Disk storage unit 38 is coupled to database server 22 and directory server 34. Servers 22, 28, 30, 32, 34, and 36 are coupled in a local area network (LAN) 40. In addition, a system administrator's workstation 42, a user workstation 44, and a supervisor's workstation 46 are coupled to LAN 40. Alternatively, workstations 42, 44, and 46 are coupled to LAN 40 using an Internet link or are connected through an Intranet.

Each workstation, 42, 44, and 46 is a personal computer having a web browser. Although the functions performed at the workstations typically are illustrated as being performed at respective workstations 42, 44, and 46, such functions can be performed at one of many personal computers coupled to LAN 40. Workstations 42, 44, and 46 are illustrated as being associated with separate functions only to facilitate an understanding of the different types of functions that can be performed by individuals having access to LAN 40.

Server system 18 is configured to be communicatively coupled to various individuals, including employees 48 and to third parties, e.g., clients/customers 52, using an ISP Internet connection 54. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 40 could be used in place of WAN 50.

In the exemplary embodiment, any authorized individual having a workstation 56 can access BISUI system 26. At least one of the client systems includes a manager workstation 58. Workstations 56 and 58 are personal computers configured to communicate with server system 18. Furthermore, fax server 32 communicates with client systems, including a client system 58 using a telephone link. Fax server 32 is configured to communicate with other client systems 42, 44, and 46 as well.

Workstations 42, 44, 46, 56 and 58 include computers that may include a device, such as, but not limited to, a floppy disk drive or CD-ROM drive, for reading data including the methods for quickly and accurately accessing baggage information from a computer-readable medium, such as a floppy disk, a compact disc-read only memory (CD-ROM), a magneto-optical disk (MOD), or a digital versatile disc (DVD). Moreover, workstations 42, 44, 46, 56 and 58 include display devices, such as, but not limited to, liquid crystal displays (LCD), cathode ray tubes (CRT) and color monitors. Furthermore, workstations 42, 44, 46, 56 and 58 include input devices such as, but not limited to, a mouse (not shown), a keyboard (not shown) and a graphical user interface (not shown). In the exemplary embodiment, the graphical user interface is incorporated into the display device. The graphical user interface may include buttons or icons shown on the display device. During operation, security personnel depress at least one button or icon to initiate commands performed by a processor.

Application server 28 includes a processor (not shown) and a memory (not shown). It should be understood that, as used herein, the term processor is not limited to just those integrated circuits referred to in the art as a processor, but broadly refers to a computer, a microcontroller, a microcomputer, a programmable logic controller, an application specific integrated circuit, and any other programmable circuit. It should be understood that the processor executes instructions stored in application server 28. The above examples are exemplary only, and are thus not intended to limit in any way the definition and/or meaning of the term “processor”.

The memory (not shown) can be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disk and disk drive, a writeable or re-writeable optical disk and disk drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disk, such as a CD-ROM or DVD-ROM disk, and disk drive or the like.

In the exemplary embodiment, a plurality of user interface buttons or icons are used to facilitate data entry and storage, and accessing stored data. The plurality of user interface buttons or icons may be used to classify items of interest. These items of interest are divided into a plurality of categories that generally define typical items encountered in baggage inspections. Typical categories may include, but not be limited to, books, food, and toiletries.

The plurality of user interface buttons or icons may also be used to facilitate storing information that identifies the item of baggage subject to inspection. More specifically, the graphical interface buttons or icons may be used to facilitate entering and storing information, such as, but not limited to, Baggage Identification Number (BIN), passenger name, name of airline, and/or the baggage's destination. It should be understood that the BIN is an IATA (International Air Transport Association) code. More specifically, the BIN is a prominently displayed bar code printed on a baggage tag that represents a ten-digit code. It should be appreciated that although the exemplary embodiment describes the BIN as representing a ten-digit code, in other embodiments, the BIN may represent any multi-digit code that enables BIS system 26 to function as described herein. Moreover, it should be appreciated that although the BIN is represented by a bar code in the exemplary embodiment, in other embodiments, the BIN may be any type of symbol or indicator that may be detected and read by a scanner included in inspection workstation 14.

In the exemplary embodiment, BIS system 26 includes a plurality of predetermined choices that each correspond to an item that may typically be contained in baggage. Security personnel access the predetermined choices using the graphical interface buttons or icons that correspond to each of the predetermined choices. During scanning, if an item corresponding to one of the predetermined choices is detected in the baggage, security personnel depress the button or icon corresponding to the item. By depressing the button or icon, security personnel designate the chosen item as information to be entered, stored and associated with the item of inspected baggage. Thus, BIS system 26 facilitates reducing the amount of time required to enter information regarding each item of baggage subject to inspection.

It should be understood that the predetermined choices may be modified based on security personnel experience or based on data collected over an extended period of time. For example, BIS system 26 may be programmed to include predetermined choices regarding a wide variety of common items that may cause false alarms during the initial screening process. Such items include, but are not limited to, contact lens solution.

It should be understood that BIS system 26 identifies thousands of items of baggage that security personnel are required to closely scrutinize and manually inspect. Known methods of baggage inspection require manually entering information in a logbook. Such information includes, but is not limited to, the name and identification number of the person conducting the inspection, the BIN, the bag's owner, the bag's destination and the bag's contents. Manually entering this information for a single baggage inspection takes relatively little time. However, manually entering this information for thousands of daily baggage inspections takes a great deal of time. Moreover, security personnel may be required to manually enter redundant information about an item of baggage into the logbook. For example, repeatedly entering the same security personnel identification information into the logbook. As another example, a bag may contain a certain kind of perfume. The perfume may be detected each time the bag is inspected, causing an alarm condition that requires documentation in the logbook for each time it is detected. It should be appreciated that should there be a problem identified with a baggage inspection, it is also time consuming and cumbersome to search manual entries in the logbook.

Consequently, the plurality of graphical interface buttons or icons may also be used by security personnel to enter information about security personnel conducting each baggage inspection. More specifically, for each item of baggage BIS system 26 prompts security personnel to enter information about security personnel conducting the baggage inspection, such as, but not limited to, the security personnel's name and identification number. BIS system 26 stores the security personnel's information and associates it with the particular item of baggage inspected. For situations where the same security personnel inspect several items of baggage, the graphical user interface may include buttons or icons that associate the stored security personnel information with each subsequent item of baggage inspected by the same security personnel. Because a large number of security personnel are required to inspect thousands of items of baggage daily, buttons or icons of BIS system 26 allow quick, accurate and repeated association of proper security personnel information with each item of baggage inspected.

It should be appreciated that in the exemplary embodiment BIS system 26 stores the time and date of each baggage inspection and associates the time and date with the corresponding baggage inspection. Moreover, BIS system 26 allows security personnel of BIS system 26 to enter and store security personnel information into the BIS system 26. Graphical user interface buttons and icons are used to facilitate accessing the name and identification number for security personnel. The buttons and icons also facilitate associating the corresponding security personnel information with each item of baggage inspected. Thus, security personnel save time because they are not required to repeatedly enter security personnel identifying information into a logbook for each item of baggage inspected.

It should be appreciated that baggage inspection information for each item of baggage is generally entered and stored in BIS system 26 during the initial inspection. After entry, during subsequent inspections at other locations within the same airport, or at destination airports, the inspection information for each item of baggage may be accessed through BIS system 26. For example, during an initial baggage inspection a scanning system may detect potentially dangerous contraband. If the potentially dangerous contraband is determined to be safe, the item is considered a false positive item. Information about the inspection and the false positive item is entered and stored in BIS system 26. During subsequent inspections, should another scanning system identify the same potentially dangerous contraband, security personnel may access the information regarding the initial inspection through BIS system 26. By accessing the initial inspection information through BIS system 26, security personnel are able to determine that the baggage should not be manually inspected again because identity of the potentially dangerous contraband is known from the initial inspection and provided by BIS system 26.

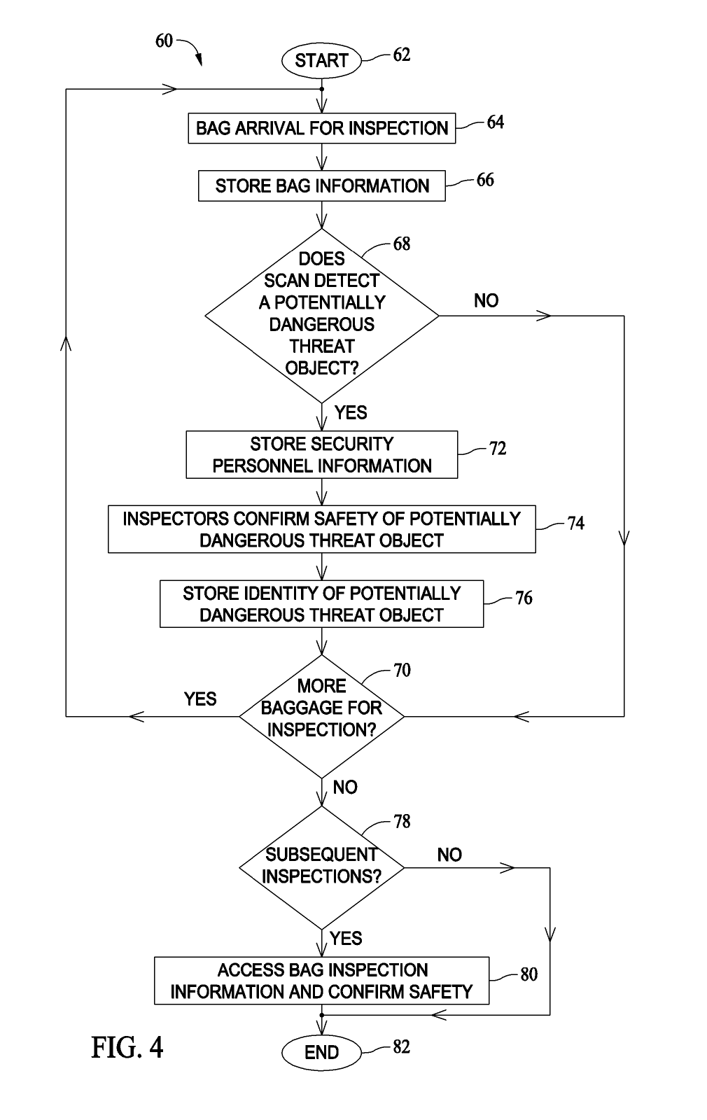

FIG. 4 is a flowchart 60 illustrating exemplary processes used by BIS system 26 (shown in FIG. 3) for quickly and accurately entering and storing baggage information. For BIS system 26, initial baggage inspection starts 62 when an item of baggage arrives for inspection 64 and is positioned at inspection workstation 14. Information about the item of baggage is entered and stored 66 into BIS system 26. Specifically, the BIN, time stamp indicating the time and date of inspection, baggage owner and baggage destination are entered and stored into BIS system 26. Next, the item of baggage is passed through a scanning system which may detect potentially dangerous contraband 68. If potentially dangerous contraband is not detected, additional baggage may be inspected 70. Otherwise, if potentially dangerous contraband is detected, the name and identification number of security personnel assigned to manually inspect the baggage are entered and stored 72 in BIS system 26. Next, security personnel manually inspect and determine the identity of the potentially dangerous contraband 74. The identification of the potentially dangerous contraband is determined and stored 76 in BIS system 26. If the potentially dangerous contraband is determined to be a safe material, object or item, BIS system 26 stores the item as a false positive item and associates it with the inspected baggage. If no more baggage requires inspection, subsequent inspections are performed 78.

If an item of baggage is subsequently scanned or otherwise inspected 78, and potentially dangerous contraband is detected, security personnel are able to access the baggage data 80 entered into BIS system 26 during the initial inspection. Security personnel are able to confirm 80 that the contraband is not dangerous by identifying the false positive items stored during the initial baggage inspection. Thus, security personnel are not required to devote valuable time repeatedly manually inspecting the same item of baggage to identify potentially dangerous contraband. This process is repeated for each subsequent baggage inspection experienced by an item of baggage. Processing then ends 82.

In the example embodiment, a computer system accurately records and tracks the date and time of initial baggage inspections and any potential threat objects detected. More specifically, a method for entering and storing initial baggage inspection information in airports is provided where a user is able to immediately and accurately access information regarding baggage scanning and manual baggage inspection. As a result, during subsequent inspections screening time is reduced because security personnel do not conduct redundant manual inspections and are able to accurately and immediately identify and locate a specific baggage inspection without spending time searching through a logbook. Quickly and accurately verifying baggage inspection information facilitates reducing the amount of time devoted to duplicate manual inspections and claims paid for lost or damaged personal items. The screening system may be continuously updated to include information to facilitate reducing false positives in the inspection process.

While the invention has been described in terms of various specific embodiments, the description of the various embodiments is illustrative only and is not to be construed as limiting the invention. Various other modifications and changes may occur to those skilled in the art without departing from the spirit and scope of the invention.

What is claimed is:

1. A method of inspecting baggage comprising:
establishing an inspection workstation comprising an inspection area and a scanning system;
providing a computer system including a graphical user interface comprising a plurality of icons;
scanning at least one item of baggage for contraband during an initial inspection;
detecting at least one item of contraband, determining an identity of the at least one item of contraband and determining whether the at least one item of contraband is safe; and
storing the identity of the at least one item of contraband in the computer system and associating the identity of the at least one item of contraband with the at least one item of baggage.

2. A method in accordance with claim 1 further comprising:
scanning the item of baggage during at least one subsequent inspection and detecting the at least one item of contraband; and
using the computer system to determine the identity of the at least one item of contraband.

3. A method in accordance with claim 1 further comprising storing the identity of the at least one item of contraband as a false positive item when the at least one item of contraband is safe.

4. A method in accordance with claim 3 further comprising defining a plurality of items as false positive items and providing at least one of the plurality of icons to correspond with each of the false positive items.

5. A method in accordance with claim 1 wherein associating the identity of the at least one item of contraband with the item of baggage further comprises selecting at least one of the plurality of icons to store the identity of the at least one item of contraband in the computer system and to associate the identity of the at least one item of contraband with the item of baggage.

6. A method in accordance with claim 1 further comprising storing an identity of security personnel responsible for inspecting the item of baggage on the computer system and associating the identity of security personnel with the item of baggage.

7. A method in accordance with claim 5 further comprising selecting at least one of the plurality of icons to associate the identity of security personnel responsible for inspecting subsequent items of baggage, with each subsequent item of baggage.

8. A method in accordance with claim 1 further comprising associating a baggage identification number, a passenger name and a destination with the at least one item of baggage.

9. A system of inspecting baggage comprising:
an inspection workstation including:
an inspection area;
a scanning system configured to scan at least one item of baggage for contraband during an initial inspection; and
a user interface configured to detect at least one item of contraband, store an identity of the at least one item of contraband, and associate the identity with the at least one item of baggage, such that if the at least one item of baggage is subsequently scanned and the at least one item of contraband detected, the user interface determines the identity of the at least one item of contraband.

10. A system in accordance with claim 9 wherein the identity of the at least one item of contraband is stored when the at least one item of contraband is determined safe.

11. A system in accordance with claim 10 where the at least one item of contraband is stored in the user interface as a false positive item.

12. A system in accordance with claim 10 wherein a plurality of items are defined as false positive items and at least one of a plurality of icons corresponds to each of the false positive items.

13. A system in accordance with claim 9 wherein security personnel determine the identity of the at least one item of contraband and whether the at least one item of contraband is safe.

14. A system in accordance with claim 9 wherein an identity of security personnel responsible for inspecting the at least one item of baggage is stored on the user interface and associated with the at least one item of baggage.

15. A system in accordance with claim 14 wherein the user interface further comprises a plurality of icons such that when at least one of the icons is selected the identity of security personnel responsible for inspecting subsequent items of baggage is associated with each subsequent item of baggage.

16. A baggage inspection apparatus comprising:
a scanning system configured to scan at least one item of baggage during an initial inspection; and
a processor configured to:
detect at least one item of contraband;
store an identity of the at least one item of contraband; and
associate the identity with the at least one item of baggage, such that if the at least one item of baggage is subsequently scanned and the at least one item of contraband detected, the processor provides the identity of the at least one item of contraband.

17. A baggage inspection apparatus in accordance with claim 16 wherein said processor is further configured to associate an identity of security personnel responsible for inspecting the at least one of baggage with the at least one item of baggage.

18. A baggage inspector apparatus in accordance with claim 16 further comprising a graphical user interface comprising a plurality of icons.

19. A baggage inspection apparatus in accordance with claim 18 wherein said processor is further configured to store a plurality of items as false positive items and associate at least one of the plurality of icons with a corresponding false positive item.

20. A baggage inspection apparatus in accordance with claim 16 wherein said processor is configured to associate a baggage identification number, a passenger name and a destination with the at least one item of baggage.
